(19) United States
(12) Patent Application Publication
(10) Pub. No.: US 2009/0287488 A1
(43) Pub. Date: Nov. 19, 2009

(54) TEXT DISPLAY, TEXT DISPLAY METHOD, AND PROGRAM

(75) Inventor: Ken Hanazawa, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 12/294,318

(22) PCT Filed: Mar. 16, 2007
(86) PCT No.: PCT/JP2007/055374

§ 371 Date: Sep. 24, 2008

(30) Foreign Application Priority Data
Mar. 24, 2006 (JP) 2006-082658

(51) Int. Cl. G10L 15/26

(52) U.S. Cl. 704/235; 704/E15.043

(57) ABSTRACT

A text display in which speech information can be effectively conveyed in a text to the user. The text display comprises a speech input section (101) for inputting a speech, a storage section (130) in which a recognition dictionary for converting the speech information into a text is stored, an output section (105) for displaying the text, and a control section (120) for recognizing a word or a word line corresponding to a speech with reference to the recognition dictionary upon input of the speech and obtaining the result of the recognition including the word or the word line and its importance, computing the display time during which the result of the recognition is displayed in response to the importance, and allowing the output section to display the result of the recognition more than the computed display time.

### APPLICABLE FIELD IN THE INDUSTRY

The present invention relates to a text display for, synchronously with inputting of a speech, displaying a text thereof, a text display method, and a program for causing a computer to executing its method.

### BACKGROUND ART

The device for automatically displaying a caption sentence in a real-time basis with a speech recognition, which is used in a TV broadcast, a TV telephone, a Web conference, etc., has been developed (see Patent document 1). The conventional caption sentence display will be explained briefly.

FIG. 5 is a block diagram illustrating one configuration example of the conventional caption sentence display. The conventional caption sentence display is configured to include a speech input section 201 for inputting a speech, a storage section 230 in which a recognition dictionary 203 for recognizing the speech has been stored, a control section 220 including a speech recognizing means 202 for recognizing the inputted speech, and an output section 204 for displaying a text. A microphone stands for the speech input section 201. As a rule, the conventional caption sentence display shown in FIG. 5 performs a speech recognition process upon receipt of a speaker's utterance, and displays a word or a word line, being a recognition result, slightly later than the reception time of the above speech. When the next utterance has already started at a time point that the above recognition result has been displayed, the caption sentence display makes it a rule to similarly display the next recognition result after displaying the above recognition result for a constant time.

FIG. 6 is a view illustrating a specific example of a speech being inputted and its recognition result. Herein, it is assumed that the situation is a Web conference employing portable telephones, and the portable telephone has a configuration shown in FIG. 5. The portable telephone, upon receipt of an input speech 501 as shown in FIG. 6, performs a recognition process for each section in which the speech has been detected, and displays caption sentences 502a up to 502d in its order for a constant time, respectively. As shown in a display time of FIG. 6, the portable telephone displays each of the caption sentences 502a to 502d for a constant time T0 during a time t1 to t5. In such a manner, the portable telephone displays the recognized word or word line for a certain constant time, or only for the time until the next recognition result is obtained.

Patent document 1: JP-P2002-342311A

### DISCLOSURE OF THE INVENTION

### Problems to be Solved by The Invention

As is often the case, the conventional method mentioned above causes a user to miss a speech in some cases, and to miss a recognition result of the caption sentence in some cases when the speech that becomes an object of recognition is continuously made and yet the space and the time for displaying the recognition result are not enough. In this case, it causes a problem that the user cannot perceive an important word even though the important word is included in the speech and the caption sentence because the caption sentence is switched one after another irrespective of its importance. In particular, the portable telephone, which, as a rule, has a smallest display screen size among information processing devices such as a laptop-type personal computer and a desktop-type personal computer, is difficult to display many caption sentences and their histories, and easily causes the foregoing problem.

The present invention has been accomplished so as to solve the point at issue as mentioned above that the related art involves, and has an object of providing a text display, a text display method, and a program for causing a computer to execute its method that make it possible to efficiently convey information by a speech to a user with a text.

### Means to Solve the Problem

The text display of the present invention for accomplishing the above-mentioned object is configured to include a speech input section for inputting a speech, a storage section in which a recognition dictionary for converting speech information into a text has been stored, an output section for displaying the text, and a control section for, when a speech is inputted, recognizing a word or a word line that corresponds to the above speech by making a reference to the recognition dictionary, obtaining a recognizing result including the above word or the above word line, and its importance, computing a display time of the above recognition result responding to the above importance, and causing the output section to display the above recognition result for the computed display time or more.

Further, the text display could be a device of which the control section decides an importance of the recognition result with one of a reliability degree at which the speech being inputted is recognized, a word importance described in the recognition dictionary, and a word importance designated by the user, or a combination thereof.

Further, the text display could be a device of which the control section causes the output section to emphatically displays the recognition result, of which the display time has been decided so that it is longer as compared with another recognition result from a computation result of the display time, with one of an underlining operation, an inverse displaying operation, an operation of changing a font, a size, or a color, or a combination thereof.

In the present invention, when information of the inputted speech is recognized, the recognition result is displayed in the output section for the computed time or more responding to its importance. For this, making a configuration so that the recognition result having a higher importance is displayed for a longer time allows important information to be easily conveyed to the user.

The text display method of the present invention for accomplishing the above-mentioned object, which is a text display method being performed by the information processing device for converting the speech into a text, is a method of storing a recognition dictionary for converting the speech information into the text in the storage section, when a speech is inputted, recognizing a word or a word line that corresponds to the above speech by making a reference to the recognition dictionary, obtaining a recognizing result including the word or the word line and its importance, computing a display time of the recognition result responding to the importance, and causing the output section to display the above recognition result for the computed display time or more.

Further, the text display method could be a method of deciding an importance of the recognition result with one of a reliability degree, at which the speech being inputted is recognized, a word importance described in the recognition dictionary, and a word importance designated by the user, or a combination thereof.

Further, the text display method could be a method of causing the output section to emphatically display the recognition result, of which the display time has been decided so that it is longer as compared with another recognition result from a computation result of the display time, with one of an underlining operation, an inverse displaying operation, an operation of changing of a font, a size, or a color, or a combination thereof.

The program of the present invention for accomplishing the above-mentioned object, being a program for causing a computer to execute a process of converting the speech into a text and displaying it, is for causing the computer to execute the process including: a step of storing a recognition dictionary for converting the speech information into a text in the storage section; a step of, when a speech is inputted, recognizing a word or a word line that corresponds to the above speech by making a reference to the recognition dictionary, a step of obtaining a recognizing result including the word or the word line, and its importance; a step of computing a display time of the recognition result responding to the importance; and a step of causing the output section to display the recognition result for the computed display time or more.

Further, the program could be a program for including a step of deciding an importance of the recognition result with one of a reliability degree, at which the speech being inputted is recognized, a word importance described in the recognition dictionary, and a word importance designated by the user, or a combination thereof.

Further, the program could be a program for including a step of emphatically displaying the recognition result, of which the display time has been decided so that it is longer as compared with another recognition result from a computation result of the display time, with one of an underlining operation, an inverse displaying operation, an operation of changing a font, a size, or a color, or a combination thereof.

### An Advantageous Effect of the Invention

The present invention has an effect that giving the recognition result having a higher importance a priority, thereby to display it for a longer time allows the important recognition result to be left to the output section as a history even though the display screen is switched. Thus, the present invention enables information to be efficiently conveyed to the user even though the location and the time for displaying the recognition result is not enough.

### BRIEF DESCRIPTION OF THE DRAWINGS

FIG. 1 is a block diagram illustrating one configuration example of the text display of this embodiment.

FIG. 2 is a flowchart illustrating an operational procedure of the text display of this embodiment.

FIG. 3 is a view illustrating a description example of the recognition dictionary in this example.

FIG. 4 is a view illustrating one example of the input speech and the recognition result in this example.

FIG. 5 is a block diagram illustrating one configuration example of the conventional text display.

FIG. 6 is a view illustrating a specific example of the input speech and the recognition result in the conventional case.

### DESCRIPTION OF NUMERALS

101 speech input section

102 speech recognizing means

103 recognition dictionary

104 display time computing means

105 output section

120 control section

130 storage section

### BEST MODE FOR CARRYING OUT THE INVENTION

The text display of the present invention is characterized in obtaining a recognizing result recognized from the input speech and its importance, computing a display time responding to its importance, and displaying the recognition result for the computed display time or more.

Next, the text display of this embodiment will be explained in details by making a reference to the accompanied drawings.

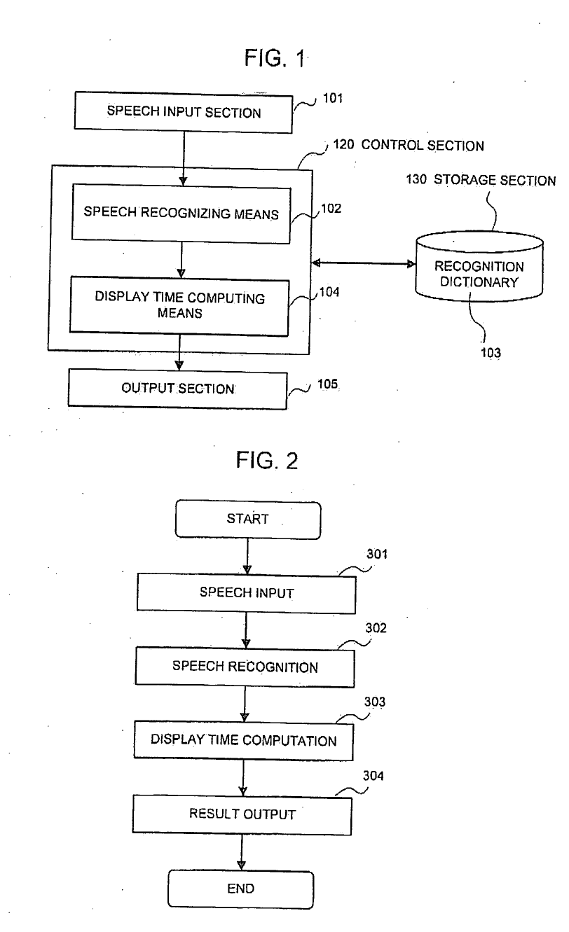

FIG. 1 is a block diagram illustrating one configuration example of the text display of this embodiment. The text display of this embodiment includes a speech input section 101 for inputting a speech, a storage section 130 in which a recognition dictionary 103 has been stored, a control section 120 including a speech recognizing means 102 for recognizing the inputted speech by employing the recognition dictionary 103 and outputting a word or a word line, being a recognition result, and its importance, and a display time computing means 104 for computing a display time from the importance, and an output section 105 for displaying the recognition result. The control section 120 causes the output section 105 to display the recognition result for the display time computed responding to the importance by the display time computing means 104.

The control section 120 includes a CPU (Central Processing Unit) for executing a predetermined process according to a program, and a memory for storing the program. The CPU executes the program, thereby allowing the speech recognizing means 102 and the display time computing means 104 to be virtually configured within the control section 120.

An operation of the text display of this embodiment will be explained. FIG. 2 is a flowchart illustrating an operational procedure of the text display.

As shown in FIG. 2, the speech is inputted via the speech input section 101 (step 301), and the speech recognizing means 102, upon receipt of a data of the speech from the speech input section 101, recognizes the speech by making a reference to the recognition dictionary 103 stored in the storage section 130 (step 302). Continuously, the speech recognizing means 102 outputs the recognition result including the word or the word line, and obtains its importance. And, it outputs the recognition result and its importance to the display time computing means 104. The display time computing means 104, upon receipt of the recognition result and information of its importance from the speech recognizing means 102, computing a display time of the recognition result responding to its importance (step 303). Thereafter, the control section 120 causes the output section 105 to display the recognition result for the display time calculated responding to its importance (step 304).

### EXAMPLE 1

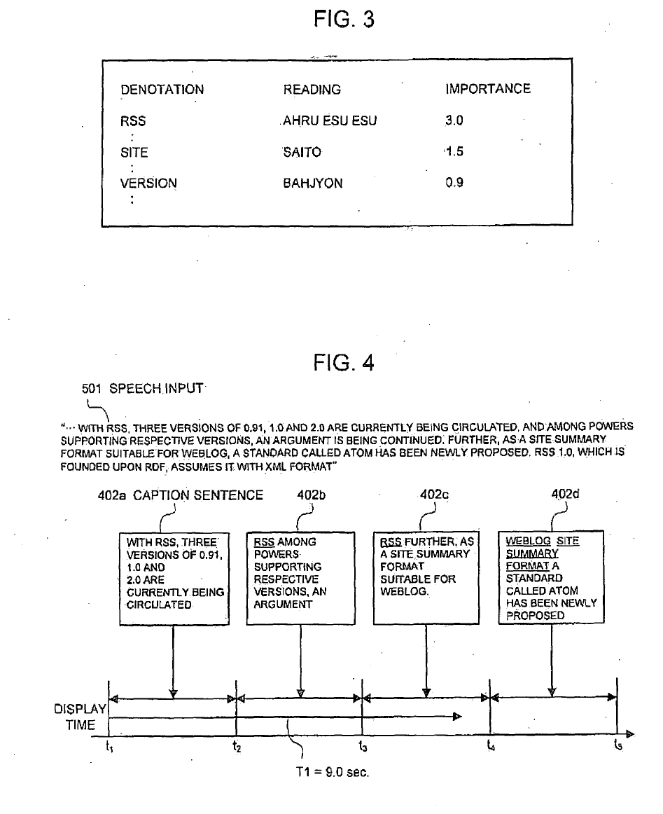

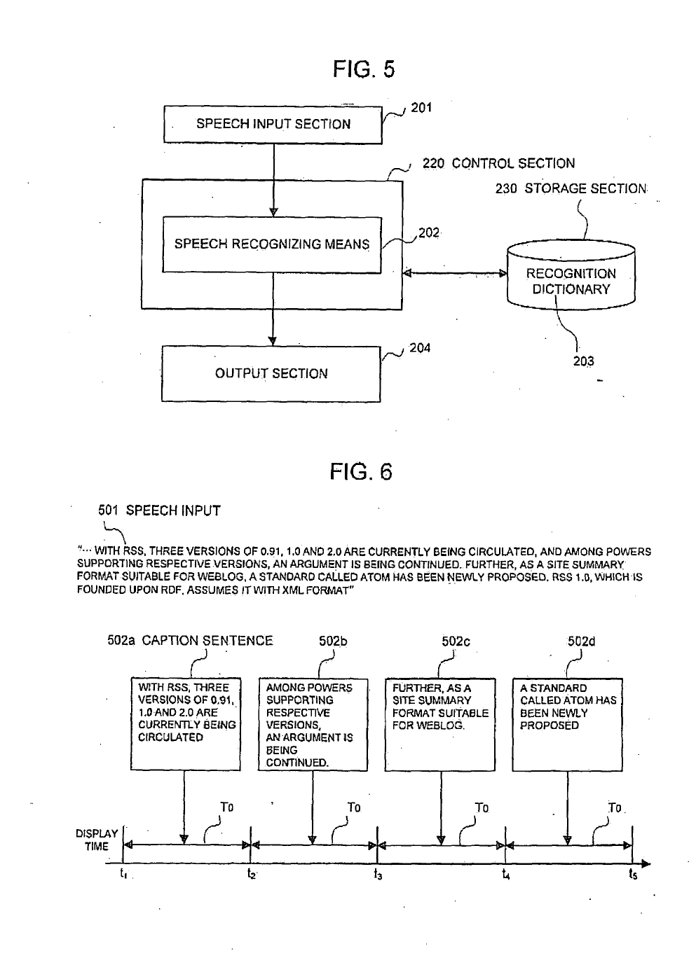

A configuration of the text display of this example will be explained. The recognition dictionary 103 of the text display of this example has information of the importance, which corresponds to each registered word, described therein. FIG. 3 is a view illustrating a description example of the recognition dictionary. As shown in FIG. 3, it is described in the recognition dictionary 103 that an importance of a word “RSS” is “3.0”, an importance of a word “site” is “1.5”, and an importance of a word “version” is “0.9”.

The speech recognizing means 102, when specifying a word or a word line by making a reference to the recognition dictionary 103, reads out its importance from the recognition dictionary 103, and delivers a recognition result including the specified word or word line, and the information of its importance to the display time computing means 104.

As one example of a computation equation for obtaining a display time T of a word w being computed by the display time computing means 104, there exists the following equation.

T=Cw×p Equation (1)

Cw is a value indicative of a word importance of the word w. P is a coefficient. As one example of p, there exists a display region-dependent constant of a system. The so-called display region-dependent constant is a value that a screen display size governs, and the smaller the screen display size, the smaller its value because a room for the location and time for displaying the recognition result is lost all the more. The display time computing means 104, upon receipt of the recognition result including the word w, and information of the importance from the speech recognizing means 102, calculates the display time T of the recognition result by employing the above-mention equation (1).

When the display time computing means 104 calculates the display time of the recognition result, the control section 120 causes the output section 105 to display the recognition result having a high importance with it underlined for a purpose of emphasis-displaying the recognition result having a high importance. In this example, it is assumed that when the display time of its recognition result is equal to or more than a first threshold, the control section 120 causes the output section 105 to emphasis-display the recognition result. The first threshold becomes a reference time for determining whether or not to emphasis-display the recognition result.

Contrarily, it is assumed that when the display time of the recognition result does not reach a second threshold, the control section 120 determines that its recognition result is a recognition result having a low importance, and causes output section 105 not to display it. The second threshold becomes a reference time for determining whether or not to display the recognition result. The first threshold and the second threshold have been pre-stored in the storage section 130.

Next, an operation ranging from the speech input to the text display in this example will be explained. FIG. 4 is a view illustrating one example of the input speech and the recognition result in this example. Herein, it is assumed that information of the speech being inputted is similar to that of the conventional case shown in FIG. 6. Further, it is assumed that the coefficient p of the above-mentioned equation (1) is 3.0. Further, it is assumed that the first threshold is 3.5 seconds, and the second threshold is 2.0 seconds. Further, it is assumed that a standard switching time period of the caption sentence is 3.5 seconds.

The speech recognizing means 102, when the speech as far as “RSS . . . is circulating” is inputted, sequentially recognizes the words or word lines by the speech. When recognizing the word “RSS”, the speech recognizing means 102 reads out its importance “3.0” from the recognition dictionary 103, and delivers the word “RSS” and information of the importance “3.0” to the display time computing means 104. The display time computing means 104 calculates a display time T1 of the word “RSS” from the above-mentioned equation (1). The display time T1 becomes 3.0×3.0=9.0 seconds. And the control section 120 recognizes that the word “RSS” becomes an object of the emphasis display because the display time of the word “RSS” is larger than the first threshold. In such a manner, after the control section 120 fixes what is emphasis-displayed with the information of the speech as far as “RSS . . . is circulating”, it causes the output section 105 to display a caption sentence 402a.

Continuously, the speech recognizing means 102 recognizes the speech as far as “And among powers supporting is being continued”. As mentioned above, it obtains the importance for each recognized word or word line, and delivers it to the display time computing means 104. And, the display time computing means 104, upon receipt of each recognition result and information of its importance, computes the display time for each word or word line. Herein, when it is assumed that the importance of “is being continued” is 0.5, the display time of the word line “is being continued” becomes 1.5 seconds. This time is smaller than the second threshold. Further, as mentioned above, the word “RSS” displayed in the caption sentence 402a has become an object of the emphasis display.

After the control section 120 causes the output section 105 to display the caption sentence 402a for 3.5 seconds, the former, at the moment of instructing the latter to makes a switchover to the next caption sentence, causes the latter to output the word “RSS” with it underlined because the display time of the word “RSS” in the caption sentence 402a has not reached 9 seconds. Further, the control section 120 causes the output section 105 to display a next caption sentence 402b except for the word line “is being continued”. In such a manner, the caption sentence 402b as shown in FIG. 4 is displayed in the output section 105.

In addition hereto, the case as well that the speech recognizing means 102 recognizes the next speech “as a site summary format for Weblog” is similar to the foregoing case. Continuously, the display time computing means 104 computes the display time for each word or word line with the recognition result being received from the speech recognizing means 102, the information of its importance, and the above-mentioned equation (1). After the display time is calculated, the control section 120, at the moment of causing the output section 105 to display a caption sentence 402c, instructs the output section 105 that the word “RSS” remains emphasis-displayed because a total of the display times of the word “RSS” in two caption sentences 402a and 402b, which is 7 seconds, does not reach 9 seconds. In such a manner, the caption sentence 402c shown in FIG. 4 is displayed in the output section 105. Additionally, the detailed explanation is omitted; however the control unit 120 makes a determination as to whether each of a word “Weblog” and a word line “site summary format” also is an object of the emphasis display, similarly to the case of the word “RSS”.

Continuously, similarly to the foregoing, the speech recognizing means 102 recognizes a speech “A standard called Atom . . . proposed”, and the display time computing means 104 calculates the display time for each word or word line. Thereafter, the control section 120, at the moment of causing the output section 105 to display the next caption sentence, instructs the output section 105 that the word “RSS” is deleted from the display because a total of the display times of the word “RSS” in three caption sentences 402a to 402c, which is 10.5 seconds, is longer than 9 seconds. On the other hand, the control section 120 causes the output section 105 to emphasis-display the word “Weblog” and the word line “site summary format” because each of them has become an object of the emphasis display. As a result, a caption sentence 402d is displayed in the output section 105 as shown in FIG. 4.

As mentioned above, in this example, the display object and the display time of the recognition result are obtained by taking a level of the importance and a display constraint into consideration, thereby to make a choice of the recognition result being displayed on the display screen of which the location and time for displaying the text is not enough. And, also in the case that all of the recognition results cannot be displayed in a real time base, the information can be efficiently conveyed to the user because the recognition result that becomes an object of the emphasis display is displayed for a longer time, and the recognition result having a low importance is not displayed.

Additionally, in this example, the recognition result “RSS”, being an object of the emphasis display, was displayed for the time equivalent to three caption sentence display times (a total display time of 10.5 seconds); however a configuration may be made so that the recognition result “RSS” is deleted from the display screen when the display time of the recognition result “RSS” has reached 9 seconds

Further, the importance of the word or the word line may be previously described in the recognition diction 103 as shown in FIG. 3, and it may be changeable according to a user's profile. For example, emphasis-displaying the word, of which the importance was high at the stage of having been registered into the recognition dictionary 103 in the first place, over and over again causes the importance of its word to decline because it becomes possible for the user as well to understand the meaning of its word. The user itself may designates the word having a high importance in some cases, and may mention the numerical value indicative of the importance in some cases.

Further, the display time of the recognition result may be obtained by employing a reliability degree of the recognition instead of the importance of the word. The so-called reliability degree of the recognition is a degree indicative of adaptability between the speech data and the word or the word line that the speech recognizing means 102 has specified for the input speech by making a reference to the recognition dictionary 103. When the speech being inputted is not clear, when a plurality of the words, each of which is pronounced analogously to the other, are registered, or the like, a probability that the speech recognizing means 102 specifies a word or word line different from that of the input speech becomes high, and the reliability degree declines. The recognition result having a low reliability degree could be erroneously recognized, and when such a recognition result is emphasis-displayed, on the contrary, the user could get confused.

Further, the importance of the word or the word line may be obtained with a combination of the numerical value pre-described in the recognition dictionary 103 as shown in FIG. 3, and the reliability degree of the recognition. In this case, if the reliability degree of the recognition result is low even though the numerical value pre-described in the recognition dictionary 103 is large, a possibility of an erroneous recognition becomes high, and resultantly, its recognition result is not displayed. The erroneous recognition result having a low reliability degree is not displayed, thereby enabling an error in information transfer to be reduced. As a result, a precision in the information transfer to the user is enhanced.

In addition hereto, the importance of the word or the word line may be obtained with one of the importance pre-registered into the recognition dictionary 103, the user's designation, and the reliability degree of the recognition, or a combination thereof.

The method of the emphasis display in the example shown in FIG. 4 is a method of emphasis-displaying the word determined to be a word having a high importance and a long display time, for example, the recognition results “RSS” and “Weblog” by performing an underlining operation; however the method of the emphasis display is not limited to this method. The method of the emphasis display, in addition to it, could be a method of changing a font, a size, or a color of the text, being an object, and a method of inverse-displaying the text, being an object. Further, the method obtained by combining these methods is also acceptable. This enables the user to easily distinguish the word having a high importance and a long display time from the word other than it.

The text display of the present invention, when recognizing information of the inputted speech, causes the output section to display the recognition result responding to its importance for the computed time or more. Giving the recognition result having a high importance a priority, thereby to display it for a longer time allows the important recognition result to be left to the output section as a history even though the display screen is switched. Thus, the information can be efficiently conveyed to the user even though no enough location and time for displaying the recognition result exist.

The text display of the present invention is applicable to the application such as a caption sentence display in a TV broadcast, a TV telephone, a WEB conference, or the like. Further, it may be applied for a program for causing a computer to execute the text display method of the present invention.

1. A text display, characterized in comprising:
a speech input section for inputting a speech;
a storage section in which a recognition dictionary for converting speech information into a text has been stored;
an output section for displaying said text; and
a control section for, when a speech is inputted, recognizing a word or a word line that corresponds to the above speech by making a reference to said recognition dictionary, obtaining a recognizing result including the above word or the above word line, calculating an importance based upon a reliability degree at which the word or the word line, being the above recognition result, is recognized, computing a display time of the above recognition result responding to the above importance, and causing said output section to display the above recognition result for the computed display time or more.

2. A text display according to claim 1, characterized in that said control section decides a importance of said recognition result based upon at least one of said reliability degree, a word importance described in said recognition dictionary, and a word importance designated by a user.

3. A text display according to claim 1, characterized in that said control section causes said output section to emphatically display the recognition result, of which the display time has been decided so that it is longer as compared with another recognition result from a computation result of said display time, with one of an underlining operation, an inverse displaying operation, and an operation of changing a font, a size, or a color, or a combination thereof.

4. A text display method being performed by an information processing device for converting a speech into a text, characterized in:
storing a recognition dictionary for converting speech information into a text in a storage section;
when a speech is inputted, recognizing a word or a word line that corresponds to the above speech by making a reference to said recognition dictionary;
obtaining a recognizing result including said word or said word line;
calculating an importance based upon a reliability degree at which the word or the word line, being said recognition result, is recognized;
computing a display time of said recognition result responding to said importance; and
causing an output section to display said recognition result for the computed display time or more.

5. A text display method according to claim 4, characterized in deciding an importance of said recognition result based upon at least one of said reliability degree, a word importance described in said recognition dictionary, and a word importance designated by a user.

6. A text display method according to claim 4, characterized in causing said output section to emphatically display the recognition result, of which the display time has been decided so that it is longer as compared with another recognition result from a computation result of said display time, with one of an underlining operation, an inverse displaying operation, and an operation of changing a font, a size, or a color, or a combination thereof.

7. A program for causing a computer to execute a process of converting a speech into a text and displaying it, said program for causing said computer to execute a process including:
a step of storing a recognition dictionary for converting speech information into a text in a storage section;
a step of, when a speech is inputted, recognizing a word or a word line that corresponds to the above speech by making a reference to said recognition dictionary;
a step of obtaining a recognizing result including said word or said word line;
a step of calculating an importance based upon a reliability degree at which the word or the word line, being said recognition result, is recognized;
a step of computing a display time of said recognition result responding to said importance; and
a step of causing an output section to display said recognition result for the computed display time or more.

8. A program according to claim 7, characterized in comprising a step of deciding an importance of said recognition result based upon at least one of said reliability degree, a word importance described in said recognition dictionary, and a word importance designated by a user.

9. A program according to claim 7, characterized in comprising a step of causing said output section to emphatically display the recognition result, of which the display time has been decided so that it is longer as compared with another recognition result from a computation result of said display time, with one of an underlining operation, an inverse displaying operation, and an operation of changing a font, a size, or a color, or a combination thereof.

10. A text display according to claim 2, characterized in that said control section causes said output section to emphatically display the recognition result, of which the display time has been decided so that it is longer as compared with another recognition result from a computation result of said display time, with one of an underlining operation, an inverse displaying operation, and an operation of changing a font, a size, or a color, or a combination thereof.

11. A text display method according to claim 5, characterized in causing said output section to emphatically display the recognition result, of which the display time has been decided so that it is longer as compared with another recognition result from a computation result of said display time, with one of an underlining operation, an inverse displaying operation, and an operation of changing a font, a size, or a color, or a combination thereof.

12. A program according to claim 8, characterized in comprising a step of causing said output section to emphatically display the recognition result, of which the display time has been decided so that it is longer as compared with another recognition result from a computation result of said display time, with one of an underlining operation, an inverse displaying operation, and an operation of changing a font, a size, or a color, or a combination thereof.
